(19) United States
(12) Patent Application Publication
(10) Pub. No.: US 2020/0070073 A1
(43) Pub. Date: Mar. 5, 2020

(54) SKIMMER SCREEN APPARATUS

(71) Applicant: Richard Strohbach, Arlington, TX (US)

(72) Inventor: Richard Strohbach, Arlington, TX (US)

(21) Appl. No.: 16/560,770

(22) Filed: Sep. 4, 2019

Related U.S. Application Data
(60) Provisional application No. 62/727,169, filed on Sep. 5, 2018.

(51) Int. Cl. B01D 35/02; E04H 4/12

(52) U.S. Cl. CPC B01D 35/02; E04H 4/1272

(57) ABSTRACT

A skimmer screen apparatus including a frame member collectively formed by side arm members, extension arm members, hinge members and screen frame members, all of which collectively form a frame for receiving a screen member, wherein the frame member is positioned in front of an inflow area to a skimmer and a screen member which attachably connects to the frame member, wherein the screen member filters debris from the water entering into the skimmer.

### CROSS-REFERENCE TO RELATED APPLICATION(S)

This application claims the benefit of priority of U.S. Provisional Application No. 62/727,169 filed on Sep. 5, 2018, the disclosure of which is incorporated herein by reference in its entirety.

### FIELD OF THE INVENTION

Embodiments described herein generally relate to swimming pool filtration systems, and more particularly to a skimmer screen apparatus.

### BACKGROUND OF THE INVENTION

Conventional residential underground swimming pools may include a wall skimmer, where the skimmer resides in the wall of the swimming pool. The inflow area or mouth of the skimmer can be seen as a cut out into the wall of the swimming pool. Water from the pool flows into the mouth of the skimmer and the skimmer removes large debris from the water. Small debris and leave particles, however, are often not caught by the skimmer and may cause clogging of the skimmer which can lead to contamination of the pool. Hence, there is a need for improved pool water filtration to prevent clogging of the pool's plumbing and to prevent contamination of the pool. Moreover, there is a need to remove small debris and larger leaves, to extend the life of the pumps and filter materials of the skimmer.

### BRIEF DESCRIPTION OF THE DRAWINGS

The various advantages of the embodiments of the present disclosure will become apparent to one skilled in the art by reading the following specification and by referencing the following drawing, in which:

FIG. 1 illustrates an exemplary skimmer screen apparatus according to an embodiment of the present disclosure.

FIG. 2 illustrates an exemplary skimmer screen apparatus used in an underground pool according to an embodiment of the present disclosures.

### SUMMARY OF THE INVENTION

Exemplary embodiments disclosed herein describe a skimmer screen apparatus including a frame member and a screen member. The frame member is collectively formed by side arm members, extension arm members, hinge members and screen frame members. The frame member is positioned in front of an inflow area to a skimmer. The screen member may attachably connect to the frame member, and the screen member may filter debris from the water entering into the skimmer area.

In some exemplary embodiments, the side arm members are foldable.

In some exemplary embodiments, the extension arm members may include warning flags to alert anyone passing by pool.

In some exemplary embodiments, the screen member is a net.

In some exemplary embodiments, the screen member is a mesh net.

### DETAILED DESCRIPTION

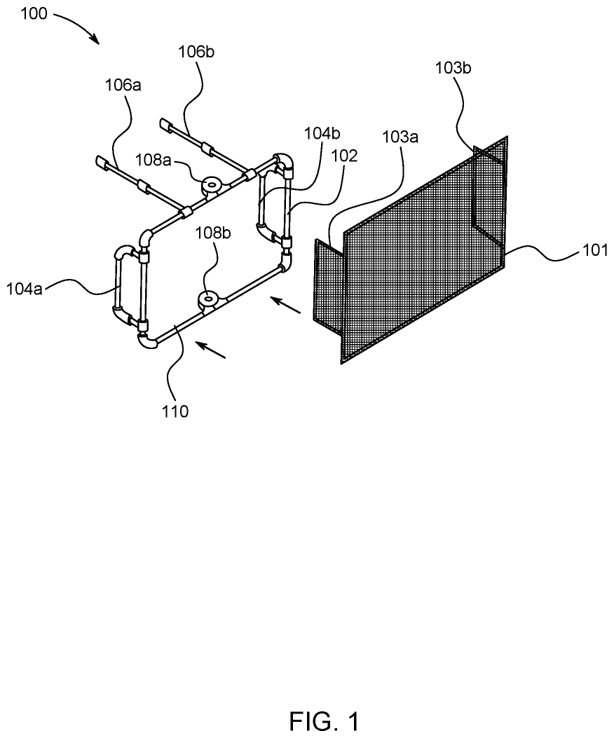

An exemplary embodiment will now be described more fully with reference to the accompanying drawings in which an example embodiment is illustrated. In FIG. 1, an exemplary skimmer screen apparatus 100 includes a screen 101 and a frame 102. The screen 101 operates as a filter by preventing debris and other particles from entering the inflow area into the skimmer. The screen is effectively a net and can be made from any suitable material that prevents particles from seeping through, such as, for example, mesh. In a preferred embodiment, an extremely fine mesh material is used for the screen to prevent anything larger than one (1) millimeter in diameter from entering the inflow area of the skimmer. The particles collected in front of the screen 101 can then be removed using a skimmer net to dip.

The screen 101 attaches to the front of the frame 102 through an attachment mechanism. The attachment mechanism can include any suitable mechanism that provides a non-permanent connection between the screen and frame (i.e. the screen may be detached from the frame), such as, for example, clip-on, adhesive material, fasteners, etc. The attachment mechanism may be located, for example, on the side arms of the screen 103a and 103b and the side arms of the frame 104a and 104b. The size of the screen 101 may include any size suitable to cover the inflow area into the skimmer for a residential pool. In an exemplary embodiment, the screen 101 is foldable.

The frame 102 includes side arm members 104a and 104b, extension arm members 106a and 106b, hinge members 108a and 108b, and screen frame member 110. The frame is made of tubing, connectors and hinges. The frame members are interconnected as shown in FIG. 1 using any suitable connector for the type of material(s) used in the construction of the frame. The frame tubing can be made of any suitable material that is not affected by UV light or chlorine, such as, for example, powder-coated aluminum. nylon, etc.

Screen frame member 110 and side arm members 104a and 104b attach to screen 101. Side arm members 104a and 104b may include a mating attachment mechanism to screen 101. Side arm members are foldable and may fold inwards in the direction of the center of screen frame member 110. In an exemplary embodiment, the size of screen frame member 110 and side arm members 104a and 104b are adjustable.

The extension arm members 106a and 106b are slats that lay on the pool deck. The extension arm members may fold down parallel to screen frame member 110. In one aspect, the extension arm members are made of a flat, heavy material to provide stability and lessen tripping. In another aspect, the length of extension arm members 106a and 106b is adjustable. In an exemplary embodiment, extension arm members 106a and 106b may include warning flags inserted therein to warn nearby walkers and/or runners of a potential tripping hazard.

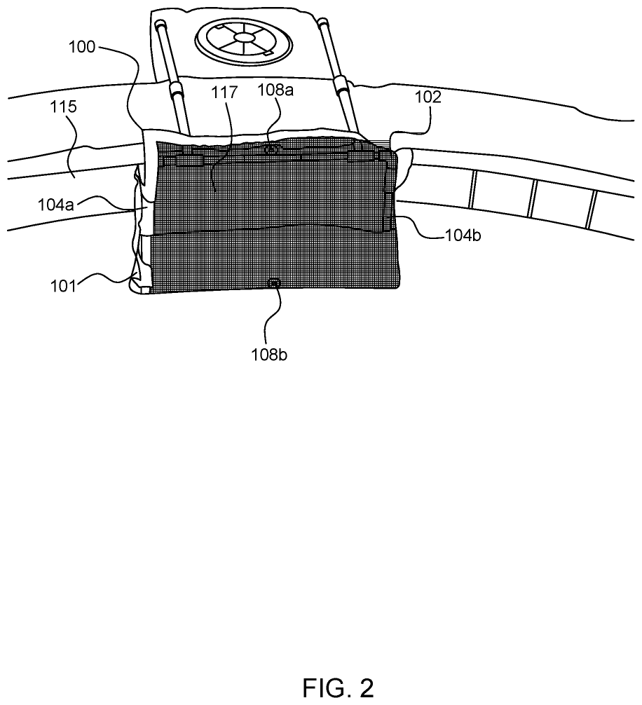

Skimmer screen apparatus 100 hangs over the side of a pool 115 to cover the inflow area 117 into the skimmer as illustrated in FIG.2 and is frictionally coupled to the wall of the pool. Hinge members 108a and 108b of the frame 102 frictionally engage the top and bottom wall area of the pool surrounding the inflow area into the skimmer. Side arm members 104a and 104b frictionally engage the side wall area of the pool surrounding the inflow area into the skimmer.

Skimmer screen apparatus 100 is collapsible and may be folded flat for storage during off-season. Moreover, because the skimmer screen 101 is detachable, replacement screens may be used when necessary.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

The disclosed embodiments are not inclusive and many other modifications and variations will be apparent to someone of ordinary skill in the art with construction skills in the related arts. Together the descriptions and accompanying illustrations seek to provide an explanation of the basic principles of the embodiment and its application. It is therefore intended that the specification and embodiments be considered as exemplary only.

What is claimed is:

1. A skimmer screen apparatus comprising:
a frame member collectively formed by side arm members, extension arm members, hinge members and screen frame members, all which collectively form a frame for receiving a screen member, wherein the frame member is positioned in front of an inflow area to a skimmer; and
a screen member which attachably connects to the frame member, wherein the screen member filters debris from the water entering into the skimmer.

2. The apparatus of claim 1, wherein the side arm members are foldable.

3. The apparatus of claim 1, wherein the extension arm members may include warning flags to alert anyone passing by pool.

4. The apparatus of claim 1, wherein the screen member is a net.

5. The apparatus of claim 4 wherein the screen member is a mesh net.
